(19) United States
(12) Patent Application Publication
(10) Pub. No.: US 2006/0177651 A1
(43) Pub. Date: Aug. 10, 2006

(54) Pressure-sensitive adhesive for surface-protective film and surface-protective film

(75) Inventor: Koji Tomita, Sayama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SOKEN CHEMICAL & ENGINEERING CO., LTD., Tokyo (JP)

(21) Appl. No.: 10/562,907

(22) PCT Filed: May 10, 2004
(86) PCT No.: PCT/JP04/06580

§ 371 Date: Dec. 30, 2005

(30) Foreign Application Priority Data
Jun. 30, 2003 (JP) 2003-187775

(51) Int. Cl. B32B 7/12

(52) U.S. Cl. 428/343

(57) ABSTRACT

It is a pressure-sensitive adhesive for a surface-protective film which comprises the following components (A) and (B):

(A) a (meth)acrylic ester copolymer obtained by copolymerizing at least the following components (a1) and (a2) (a1) 80 to 99% by mass of an alkyl (meth)acrylate in which the alkyl group has up to 12 carbon atoms; and (a2) 1 to 10% by mass of 4-hydroxybutyl acrylate or 4-hydroxybutyl methacrylate; and (B) an isocyanate crosslinking agent having a functionality of 3 or higher, the amount of the component (B) being 1 to 5 parts by weight per 100 parts by weight of the component (A). The pressure-sensitive adhesive has a gel fraction of 90% by mass or higher, a peel force as measured at a peel rate of 300 mm/min of 20 gf/inch or lower, and a peel force as measured at a peel rate of 2,000 mm/min of 50 gf/inch or lower. The pressure-sensitive adhesive for a surface-protective film of the invention has a satisfactory high-rate release property, changes little in peel force with peel rate, does not stain an adherend, and is satisfactory in properties including pot life.

### TECHNICAL FIELD

The present invention relates to a pressure-sensitive adhesive for a surface-protective film excellent in release property, and more particularly to a pressure-sensitive adhesive for a surface-protective film, for which a force required for peeling is small even at a high peel rate and a change in peel force with peel rate is small, and a surface-protective film utilizing the same.

### BACKGROUND ART

In recent years, as the development of the display field, many special optical parts are being used. Among these, as for optical films, a considerable number of optical films such as a polarizing plate, a retardation plate or a brightness improving film to be used for a liquid display, an AR film, an electromagnetic wave shielding film or an IR cut film to be used for a plasma display and the like are laminated and used.

By the time when a display is assembled, such an optical film is usually subjected to steps of punching, transporting, inspecting and the like, and a surface-protective film is usually attached to the surface of the optical film so that the optical film is not damaged, stained or the like during these steps.

Such a surface-protective film is peeled off and discarded at the time when it is no longer required after each step is completed. Since such a peeling operation is mainly carried out by hand, the peel rate is relatively high and it was difficult to make the rate constant from the initiation of peeling until the end of peeling.

In general, as the peel rate becomes high, a force required for peeling (hereinafter abbreviated as merely “peel force”) becomes high, therefore, there was a problem that the working efficiency of peeling the surface-protective film was deteriorated, or an adherend was damaged when the film was peeled off. Accordingly, a demand for a pressure-sensitive adhesive for a surface-protective film, which has a low peel force even at a high peel rate and changes little in peel force with peel rate from a viewpoint of workability has been increasing.

In general, as a pressure-sensitive adhesive for a surface-protective film, which is temporarily attached for protecting the surface of a plastic plate including the above-mentioned film to be used in the display field, a metal plate such as a stainless steel plate, a glass plate or the like, an acrylic pressure-sensitive adhesive is used. As the acrylic pressure-sensitive adhesive, one prepared by adding a crosslinking agent to a polymer obtained by copolymerizing a (meth) acrylic ester monomer and a monomer having a functional group on a side chain is well known.

As a specific acrylic pressure-sensitive adhesive for a surface-protective film, those obtained by using as the above-mentioned functional group an amide group and a hydroxyl group, and as the crosslinking agent a metal chelate compound and an isocyanate compound have been proposed (JP-A-2001-240830). However, the object of such a surface-protective film was that the peel force changes little with time and blistering does not occur during heating, and the peel force at a high peel rate was not sufficiently low.

On the other hand, as one in response to a high peel rate, those obtained by using as the above-mentioned functional group a carboxyl group and as the crosslinking agent an epoxy compound are known (JP-A-5-163468 and JP-A-11-256111). However, as for these pressure-sensitive adhesives, although a peel force at a high peel rate was low, a high peel force was needed at a low (initial) peel rate.

As a pressure-sensitive adhesive for solving such a problem, those obtained by using as the functional group a hydroxyl group and as the crosslinking agent a bifunctional isocyanate are known (JP-A-2003-041229). However, when a bifunctional isocyanate was used as the crosslinking agent, an adherend was liable to be stained, and there was a tendency that the high-rate release property was deteriorated. Further, since the content as the total isocyanate crosslinking agent was high, another problem in that the pot life of the pressure-sensitive adhesive was deteriorated or an adherend was liable to be stained occurred.

Accordingly, there has been a demand for providing a pressure-sensitive adhesive for a surface-protective film, which has a satisfactory high-rate release property, changes little in peel force with peel rate, does not stain an adherend, and is satisfactory in properties including pot life.

### DISCLOSURE OF THE INVENTION

The present inventors have made intensive studies in view of the above situation, and as a result, they found that a pressure-sensitive adhesive which is obtained by combining an isocyanate crosslinking agent having a functionality of 3 or higher with a specific polymer having a hydroxyl group as a functional group and has a specific gel fraction is the one that solves the above-mentioned problems and have completed the invention.

That is, the invention provides a pressure-sensitive adhesive for a surface-protective film, which comprises the following components (A) and (B):

(A) a (meth)acrylic ester copolymer obtained by copolymerizing at least the following components (al) and (a2):

(a1) 80 to 99% by mass of an alkyl (meth)acrylate in which the alkyl group has up to 12 carbon atoms; and

(a2) 1 to 10% by mass of 4-hydroxybutyl (meth)acrylate; and

(B) an isocyanate crosslinking agent having a functionality of 3 or higher, the amount of the component (B) being 1 to 5 parts by weight per 100 parts by weight of the component (A),

characterized in that the gel fraction is 90% by mass or higher, the peel force as measured at a peel rate of 300 mm/min is 20 gf/inch or lower, and the peel force as measured at a peel rate of 2,000 mm/min is 50 gf/inch or lower.

In addition, the invention provides a surface-protective film comprising the above-mentioned pressure-sensitive adhesive for a surface-protective film coated on one surface of a substrate for a surface-protective film.

### BEST MODE FOR CARRYING OUT THE INVENTION

An essential copolymerization component (a1) of a (meth)acrylic ester copolymer (component (A)) to be used in the invention is an alkyl acrylate in which the alkyl group has up to 12 carbon atoms or an alkyl methacrylate in which the alkyl group has up to 12 carbon atoms.

Specific examples of the copolymerization component (al) include methyl (meth)acrylate, ethyl (meth)acrylate, propyl (meth)acrylate, butyl (meth)acrylate, pentyl (meth)acrylate, hexyl (meth)acrylate, cyclohexyl (meth)acrylate, 2-ethylhexyl (meth)acrylate, octyl (meth)acrylate, nonyl (meth)acrylate, decyl (meth)acrylate, dodecyl (meth)acrylate and the like. These are used singly or in combination of two or more. Among these, an alkyl acrylate is preferred because it adjusts the glass transition temperature (Tg) of the component (A) obtained by copolymerization within a preferred range. In addition, the number of carbons in the alkyl group of the component (al) ranges preferably from 4 to 10 in order to adjust the Tg of the component (A) to be a preferred value, and is particularly preferably 8. Further, among these, 2-ethylhexyl acrylate is most preferred.

The polymerization ratio of this copolymerization component (al) in the component (A) ranges from 80 to 99% by mass (hereinafter abbreviated merely as “%”) . When it is less than 80%, after aproduct is attached, it maypeel off by itself, or a sufficient release property cannot be obtained at a low peel rate or a high peel rate. When it is higher than 99%, the polymerization ratio of the other essential copolymerization component (a2) becomes too low to obtain the gel fraction of the invention in some cases. It ranges preferably from 90 to 98%, particularly preferably from 92 to 96%.

In addition, the other essential copolymerization component (a2) of the component (A) is 4-hydroxybutyl acrylate or 4-hydroxybutyl methacrylate. This copolymerization component (a2) has 4 carbon atoms in the alkyl group and has a hydroxyl group, and adjusts the gel fraction or the like by reacting with a component (B), an isocyanate crosslinking agent having a functionality of 3 or higher, which will be described later. Among these components (a2), 4-hydroxybutyl acrylate is more preferred.

In the case of 2-hydroxyethyl (meth)acrylate, which has a hydroxyl group as with 4-hydroxybutyl (meth)acrylate, but has 2 carbon atoms in the alkyl group, a pressure-sensitive adhesive for a surface-protective film, which is excellent in low-rate (initial) release property and high-rate release property and satisfies other properties including anti-staining property, cannot be obtained.

The polymerization ratio of this copolymerization component (a2) in the component (A) ranges from 1 to 10%. When it is less than 1%, a sufficient gel fraction cannot be obtained in some cases. When it is higher than 10%, the pot life becomes short, and its workability may be deteriorated in some cases. It ranges preferably from 2 to 8%, particularly preferably from 3 to 6%.

As the copolymerization components constituting the component (A), other copolymerization components can be used in addition to the above-mentioned essential copolymerization components (a1) and (a2). Examples of the other copolymerization components include aromatic vinyl monomers such as styrene, α-methylstyrene and vinyl toluene; vinyl acetate; carboxyl group-containing monomers such as (meth) acrylic acid, itaconic acid, crotonic acid, maleic acid and fumaric acid; amide group-containing monomers such as (meth)acrylamide, N-methylol(meth)acrylamide and N-methoxyethyl(meth)acrylamide and the like.

The polymerization ratio of the other copolymerization components in the component (A) is not particularly limited, however, it is preferably 5% or lower. In particular, in the case of those having a functional group such as a carboxyl group-containing monomer or an amide group-containing monomer, it is preferably 2% or lower. Apolymer containing a functional group other than a hydroxyl group such as a carboxyl group may deteriorate a low-rate (initial) release property in some cases, therefore it is not preferred that such a group is contained in a large amount.

A method of polymerizing the copolymerization components (a1) and (a2) and, as necessary, other copolymerization components for producing an acrylic copolymer, which is the component (A), is not particularly limited, however, a radical polymerization is preferred in terms of easiness of designing polymers and when anti-staining property is considered, a solution polymerization is particularly preferred.

The molecular weight of the component (A) to be obtained is not particularly limited, however, it is preferred that the weight-average molecular weight ranges from 300,000 to 1,000,000.

In the invention, as a preferred component (A), one obtained by copolymerizing at least 90 to 99% 2-ethylhexyl acrylate and 1 to 10% 4-hydroxybutyl acrylate can be exemplified, and as a particularly preferred component (A), one obtained by copolymerizing 90 to 99% 2-ethylhexyl acrylate, 1 to 10% 4-hydroxybutyl acrylate and 0 to 1% acrylic acid can be exemplified.

The content of the component (A) to the total pressure-sensitive adhesive is not particularly limited, however, it ranges preferably from 80 to 99%, particularly preferably from 90 to 99%.

On the other hand, an isocyanate crosslinking agent having a functionality of 3 or higher (component (B)) means a compound having 3 or more isocyanate groups in one molecule. The structure thereof is not particularly limited, however, specific examples include: a compound obtained by addition reaction of a diisocyanate compound such as tolylene diisocyanate, xylylene diisocyanate, chlorophenylene diisocyanate, hexamethylene diisocyanate, tetramethylene diisocyanate, isophorone diisocyanate, diphenylmethane diisocyanate or hydrogenated diphenylmethane diisocyanate with a polyhydric alcohol such as trimethylolpropane or pentaerythritol; an isocyanate compound; an isocyanurate compound; a burette type compound; and an urethane prepolymer isocyanate obtained by addition reaction of a known polyether polyol, polyester polyol, acryl polyol, polybutadiene polyol, polyisoprene polyol and the like.

Among these components (B), as a preferred one, a trimethylolpropane adduct of tolylene diisocyanate, xylylene diisocyanate or hexamethylene diisocyanate can be exemplified. These may be used singly or in combination of two or more.

The content of the component (B) ranges from 1 to 5 parts by weight (hereinafter abbreviated merely as “part(s)”) per 100 parts of the component (A). When it is more than 5 parts, the pot life of a pressure-sensitive adhesive may be deteriorated and an adherend may be stained in some cases. When it is less than 1 part, the gel fraction may be decreased in some cases. It ranges preferably from 2 to 5 parts, particularly preferably from 2 to 4 parts.

When a bifunctional isocyanate crosslinking agent is used, an adherend is liable to be stained and a high-rate release property is also deteriorated, therefore, it is not preferred. Needless to say, a bifunctional isocyanate crosslinking agent cannot be used in place of the isocyanate crosslinking agent having a functionality of 3 or higher of the component (B) of the invention, it is not preferred that a bifunctional isocyanate crosslinking agent is contained together with the component (B) because it deteriorates the above-mentioned properties.

In the pressure-sensitive adhesive for a surface-protective film of the invention (hereinafter abbreviated merely as “pressure-sensitive adhesive of the invention”), other than the above-mentioned component (A) and component (B), a phosphate ester surfactant can be further contained as a component (C) for reducing the adhesion force. As the component (C), a phosphate ester of polyoxyethylene alkyl ether or a phosphate ester of polyoxyethylene alkyl aryl ether is preferred. In addition, as the alkyl group in the molecule of the phosphate ester of polyoxyethylene alkyl ether, one having 8 to 18 carbon atoms is preferred, and in particular, one having 8 to 14 carbon atoms is preferred. Further, as the alkyl aryl group in the molecule of the phosphate ester of polyoxyethylene alkyl aryl ether, an alkylphenyl group is preferred, and in particular, an n-nonylphenyl group is preferred. As the component (C), a mono-, di- or triphosphate ester, or a mixture thereof is used, however, a monoester is preferred. In addition, a phosphoric acid residue which is not linked by an ester bond may form a salt such as a sodium salt or a potassium salt, or may also be bound to a hydrogen atom (acid per se). These may be used singly or in combination of two or more.

The content of the component (C) is not particularly limited, however, it ranges preferably from 1 to 10 parts, particularly preferably from 1 to 5 parts per 100 parts of the component (A).

Production of the pressure-sensitive adhesive of the invention is carried out by mixing the component (A), the component (B) and, as necessary, the component (C) according to a standard method.

The pressure-sensitive adhesive of the invention obtained as described above has a gel fraction of 90% or higher. The definition of the gel fraction in the invention is based on the description in the following Examples. When the gel fraction is less than 90%, the adhesion force at the time of releasing at a low rate and at a high rate becomes too high.

In addition, it is necessary for the pressure-sensitive adhesive of the invention to have a peel force as measured at a peel rate of 300 mm/min of 20 gf/inch or lower, and a peel force as measured at a peel rate of 2,000 mm/min of 50 gf/inch or lower. The peel force of the pressure-sensitive adhesive according to the invention including the preparation of a surface-protective film is based on the description in the following Examples.

Among these, the peel force at the time of peeling at 300 mm/min indicates a low-rate release property, and the lower this peel force, the more excellent the low-rate release property. Alternatively, the peel force at the time of peeling at 2,000 mm/min indicates a high-rate release property, and the lower this peel force, the more excellent the high-rate release property.

By coating the pressure-sensitive adhesive of the invention as described above on one surface of a substrate for a surface-protective film, a surface-protective film can be obtained. As the substrate for a surface-protective film, a plastic film of polyester such as polyethylene terephthalate (PET), polyethylene, polypropylene, ethylene-vinyl acetate copolymer or the like can be preferably used. Further, this coating process is carried out by dissolving the pressure-sensitive adhesive of the invention in a solvent such as ethyl acetate, toluene or methyl ethyl ketone, adjusting the viscosity of the solution so that it is easy to apply, applying the solution uniformly onto a substrate for a surface-protective film, and allowing crosslinking reaction to proceed while drying the substrate to remove the solvent.

In general, as for a combination of a hydroxyl group-containing polymer and an isocyanate crosslinking agent, although the low-rate release property is superior, there is a tendency that the high-rate release property is inferior. On the other hand, as for a combination of a carboxyl group-containing polymer and an epoxy crosslinking agent, although the high-rate release property is superior, there is a tendency that the low-rate release property is inferior. In the meantime, the pressure-sensitive adhesive of the invention achieves both the high-rate release property and the low-rate release property by selecting types of the hydroxyl group-containing polymer and the isocyanate crosslinking agent and the mixing ratio thereof.

That is, the pressure-sensitive adhesive of the invention has a satisfactory high-rate release property as well as a low-rate (initial) release property, does not stain an adherend, and has a satisfactory pot life.

Accordingly, a surface-protective film obtained by using the pressure-sensitive adhesive of the invention can be peeled off from an adherend such as a panel without applying a strong force, therefore, there is less possibility for damaging the adherend. Further, the peel force changes little whether the film is peeled off at a high rate or a low rate, therefore, the working efficiency is not reduced even when the operation is carried out by manually.

### EXAMPLES

Hereinafter, the invention will be described in more detail with reference to Production Examples, Examples, Comparative Examples and Test Examples, however, the invention is not limited to these.

### Production Example 1

To a reactor equipped with a stirrer, a reflux condenser, a thermometer and a nitrogen charge pipe, 94.5 parts by weight (hereinafter abbreviated merely as “part(s)”) of 2-ethylhexyl acrylate (2EHA), 5 parts of 4-hydroxybutyl acrylate (4HBA), 0.5 part of acrylic acid (AA) and 150 parts of ethyl acetate were added and, with the addition of 0.2 part of azo-bis-isobutironitrile (AIBN) and under a flow of nitrogen gas, the mixture was allowed to polymerize at 68° C. for 8 hours, whereby a copolymer with a weight-average molecular weight of 500,000 was obtained. Hereinafter the copolymer is called acryl polymer A.

### Production Example 2

A copolymer with a weight-average molecular weight of 500,000 was obtained in the same manner as in Production Example 1 except that 2-hydroxyethyl acrylate (2HEA) was used in place of 4-hydroxybutyl acrylate (4HBA). Hereinafter the copolymer is called acryl polymer B.

### Example 1

A pressure-sensitive adhesive solution was obtained by adding 4 parts of Colonate L (a trifunctional crosslinking agent; manufactured by Nippon Polyurethane Co.), which is an isocyanate crosslinking agent, to an ethyl acetate solution of acryl polymer A of an amount corresponding to the amount that contains 100 parts of acryl polymer A as a solid content and mixing them. The obtained pressure-sensitive adhesive solution was coated on a polyethylene terephthalate (PET) film with a thickness of 50 μm so that the pressure-sensitive adhesive layer has a thickness of 20 μm after drying, and crosslinking reaction was allowed to proceed while removing the solvent and drying at 80° C. Subsequently, a silicone-coated PET film with a thickness of 38 μm was attached to the dried surface thereof and left at 23° C. and 65% RH for 7 days, whereby a surface-protective film was obtained.

### Example 2

A surface-protective film was obtained in the same manner as in Example 1 except that 4 parts of Duranate 24A-100 (a trifunctional crosslinking agent; manufactured by Asahi Kasei Chemicals Corporation) was used as an isocyanate crosslinking agent.

### Example 3

A surface-protective film was obtained in the same manner as in Example 1 except that as an isocyanate crosslinking agent, 2 parts of Colonate L and as a phosphate ester surfactant, 2 parts of monopolyoxyethylene nonylphenyl ether phosphate were added to the ethyl acetate solution of acryl polymer A of an amount corresponding to the amount that contains 100 parts of acryl polymer A as a solid content.

### Comparative Example 1

A surface-protective film was obtained in the same manner as in Example 1 except that 0.5 part of Colonate L was used as an isocyanate crosslinking agent.

### Comparative Example 2

A surface-protective film was obtained in the same manner as in Example 1 except that 4 parts of TETRAD-X (manufactured by Mitsubishi Gas Chemical Company Inc.), which is an epoxy crosslinking agent, was used in place of the isocyanate crosslinking agent.

### Comparative Example 3

A surface-protective film was obtained in the same manner as in Example 1 except that 4 parts of Alumichelate A (manufactured by Kawaken Fine Chemicals Co., Ltd.), which is a metal chelate compound, was used in place of the isocyanate crosslinking agent.

### Comparative Example 4

A surface-protective film was obtained in the same manner as in Example 1 except that an ethyl acetate solution of acryl polymer B of an amount corresponding to the amount that contains 100 parts of acryl polymer B as a solid content was used in place of the solution of acryl polymer A.

### Comparative Example 5

A surface-protective film was obtained in the same manner as in Example 1 except that 5 parts of Desmodule N3400 (manufactured by Sumika Bayer Urethane Co., Ltd.), which is a bifunctional isocyanate crosslinking agent, was used in place of 4 parts of Colonate L, which is an isocyanate crosslinking agent.

### Comparative Example 6

A surface-protective film was obtained in the same manner as in Example 1 except that 6 parts of Colonate L, which is an isocyanate crosslinking agent was used.

### Test Examples

By the following methods, the surface-protective films of the above-mentioned Examples 1 to 3 and Comparative Examples 1 to 6 were tested for the gel fraction, the peel force, the pot life and the anti-staining property. The test results are shown in Table 1.

(Gel Fraction)

Each of the above-mentioned surface-protective films was cut into a 50 mm×50 mm piece. From the surface-protective film obtained by cutting, the pressure-sensitive adhesive was peeled off and the initial weight of the pressure-sensitive adhesive was measured. The pressure-sensitive adhesive was dipped in 100 g of ethyl acetate and left at room temperature for 24 hours. Then, the solution was filtered through a 200-mesh metal screen and the residue remaining on the mesh was dried at 80° C. for 2 hours and weighed. The gel fraction was calculated by the following equation using the initial weight and the weight of the residue.
Gel fraction (%) 100×(weightoftheresidue)/(initial weight)
(Peel Force)

Each of the above-mentioned surface-protective films was cut into a 25 mm×150 mm piece, and the piece was attached to a polarizing plate (onto the triacetyl cellulose side) and left at room temperature for 24 hours. Then, the film was pulled up in the direction of 180° (opposite method) at a peel rate of 300 mm/min or 2,000 mm/min, and the force at the time of initiation of peeling was determined to be the peel force.

(Pot Life)

Each of the pressure-sensitive adhesive solutions after the addition of the crosslinking agent was left at 25° C. for 8 hours. Then, the condition of the solution was observed and evaluation was carried out on the basis of the following criteria.

O: There was no problem with the appearance and the coating.

x: Gelation was observed.

(Anti-Staining Property)

The condition of the surface of each of the adherends after the peel force test was observed and evaluation was carried out on the basis of the following criteria.

O: Staining was not observed at all.

x: Slight staining was observed.

Δ: Clear staining was observed.

TABLE 1

| | | Low peel rate | High peel rate | | Anti- |
|---|---|---|---|---|---|
| | Gel | (300 mm/min) | (2,000 mm/min) | | staining |
| | fraction % | gf/inch | gf/inch | Pot life | property |
| Example 1 | 92 | 10 | 40 | ◯ | ◯ |
| Example 2 | 94 | 5 | 30 | ◯ | ◯ |
| Example 3 | 90 | 5 | 35 | ◯ | ◯ |
| Comparative Example 1 | 80 | 32 | 78 | ◯ | ◯ |
| Comparative Example 2 | 44 | 112 | 268 | ◯ | ◯ |
| Comparative Example 3 | 30 | 135 | 305 | ◯ | ◯ |
| Comparative Example 4 | 91 | 20 | 65 | ◯ | ◯ |
| Comparative Example 5 | 90 | 15 | 57 | ◯ | X |
| Comparative Example 6 | 98 | 4 | 25 | X | Δ |

As shown in Table 1, the pressure-sensitive adhesives for a surface-protective film of Examples 1 to 3 were excellent in all the low-rate release property, the high-rate release property, the pot life and the anti-staining property.

### INDUSTRIAL APPLICABILITY

The pressure-sensitive adhesive for a surface-protective film of the invention has a satisfactory high-rate release property, changes little in peel force with peel rate, does not stain an adherend, and is satisfactory in properties including pot life, therefore, it can be widely used for optical films and the like.

1. A pressure-sensitive adhesive for a surface-protective film, which comprises the following components (A) and (B):
(A) a (meth)acrylic ester copolymer obtained by copolymerizing at least the following components (a1) and (a2):
(a1) 80 to 99% bymass of an alkyl (meth)acrylate in which the alkyl group has up to 12 carbon atoms; and
(a2) 1 to 10% by mass of 4-hydroxybutyl(meth)acrylate; and
(B) an isocyanate crosslinking agent having a functionality of 3 or higher, the amount of the component (B) being 1 to 5 parts by weight per 100 parts by weight of the component (A),
characterized in that the gel fraction is 90% by mass or higher, the peel force as measured at a peel rate of 300 mm/min is 20 gf/inch or lower, and the peel force as measured at a peel rate of 2,000 mm/min is 50 gf/inch or lower.

2. The pressure-sensitive adhesive for a surface-protective film according to claim 1, further comprising a phosphate ester surfactant as a component (C).

3. The pressure-sensitive adhesive for a surface-protective film according to claim 2, wherein the component (C) is a phosphate ester of polyoxyethylene alkyl ether or a phosphate ester of polyoxyethylene alkyl aryl ether.

4. A surface-protective film characterized by comprising a pressure-sensitive adhesive for a surface-protective film according to any one of claims 1 to 3 coated on one surface of a substrate for a surface-protective film.
